(19) United States
(12) Patent Application Publication
(10) Pub. No.: US 2012/0085316 A1
(43) Pub. Date: Apr. 12, 2012

(54) DIRECT-INJECTION INTERNAL COMBUSTION ENGINE WITH INJECTION NOZZLE

(75) Inventors: Guohui Chen, Aachen (DE); Werner Willems, Aachen (DE); Claudia Conee, Aachen (DE); Arnd Sommerhoff, Aachen (DE)

(73) Assignee: FORD GLOBAL TECHNOLOGIES, LLC, Dearborn, MI (US)

(21) Appl. No.: 13/269,471

(22) Filed: Oct. 7, 2011

(30) Foreign Application Priority Data
Oct. 11, 2010 (DE) 102010038082.2

(51) Int. Cl. F02B 77/00

(52) U.S. Cl. 123/298

(57) ABSTRACT

A direct-injection internal combustion engine is provided. The engine comprises at least one cylinder in which a combustion chamber is jointly formed by a piston crown of a piston and by a cylinder head, each cylinder having an inlet opening for the supply of fresh air, and an injection nozzle which is arranged in the cylinder head on the opposite side of the piston crown, on which injection nozzle, at a free end projecting into the combustion chamber, are provided a plurality of nozzle holes for the direct injection of the fuel, the injection nozzle being arranged eccentrically, spaced apart from a longitudinal axis of the cylinder and inclined at an angle α to the longitudinal axis of the cylinder, at least two of the plurality of nozzle holes including opening cross-sections of different size. In this way, an equal fuel distribution in the cylinder may be provided.

### RELATED APPLICATIONS

The present application claims priority to German Patent Application No. 102010038082.2, filed on Oct. 11, 2010, the entire contents of which are hereby incorporated by reference for all purposes.

### FIELD

The disclosure relates to a direct-injection internal combustion engine.

### BACKGROUND AND SUMMARY

In the development of internal combustion engines, it is constantly sought to minimize fuel consumption, reduce pollutant emissions and reduce costs. The latter may be achieved in particular by reducing the number of components. A reduction in the number of components reduces the production costs for components overall, reduces the provision costs incurred inter alia in the administration and storage of the components, and the assembly costs during the assembly of the internal combustion engine.

In this context, it may be expedient to reduce the number of components of the valve drive. To reduce the number of valve drive components, the combustion chambers may alternatively be provided with only one inlet opening. Along with the further inlet openings, the associated valves and the components of the actuating device thereof, specifically cams, oscillating arms, rocker arms and/or tappets, are eliminated.

Since it is however a basic aim during the charge exchange for the largest possible inlet opening cross section to be opened as quickly as possible in order to ensure the best possible charging of the combustion chamber with fresh air, it is necessary, when using only one inlet opening per cylinder, for said opening to be of correspondingly large dimensions in relation to embodiments with two or more inlet openings. Such a design of the inlet opening leads to a modified installation space situation in the cylinder, that is to say in the cylinder head, which in the case of a direct-injection internal combustion engine may accommodate not only the inlet and outlet openings and the associated valves but also the injection nozzle.

A single large inlet opening per cylinder necessitates an eccentric arrangement of the injection nozzle spaced apart from the longitudinal axis of the cylinder. To provide adequate installation space for the inlet valve and the inlet-side actuating device, in particular the inlet camshaft, the injection nozzle is additionally arranged so as to be inclined by an angle α with respect to the longitudinal axis of the cylinder.

Such an arrangement of the injection nozzle has an effect on the mixture formation in the cylinder, that is to say in the combustion chamber. The inclined installation position of the nozzle has the effect that the fuel jets emerging from the nozzle holes do not have uniform impetus. This results from the fact that some injection-influencing factors upstream of the nozzle outlet opening vary from nozzle hole to nozzle hole on account of the inclination of the nozzle. Depending on the position of the individual nozzle hole, the fuel flow introduced into the cylinder through said nozzle hole is deflected more or less intensely and more or less frequently on its path to the nozzle outlet opening. The pressure losses arising here in the fuel have a significant influence on the impetus of the fuel jet entering into the combustion chamber.

An injection nozzle of uniform design with regard to the nozzle holes may reduce a possible source of erroneous installation during assembly. However, the non-uniform impetus of the fuel jets emerging from the nozzle holes results in a very lean or very rich fuel/air mixture in locally limited regions, in particular in a piston depression which may be provided. This has an adverse effect on the combustion and the formation of pollutants, in particular the emissions of unburned hydrocarbons.

The inventors have recognized the issues with the above approach and provide an engine system herein to at least partly address them. In one embodiment, a direct-injection internal combustion engine comprises at least one cylinder in which a combustion chamber is jointly formed by a piston crown of a piston and by a cylinder head, each cylinder having an inlet opening for the supply of fresh air, and an injection nozzle which is arranged in the cylinder head on the opposite side of the piston crown, on which injection nozzle, at a free end projecting into the combustion chamber, are provided a plurality of nozzle holes for the direct injection of the fuel, the injection nozzle being arranged eccentrically, spaced apart from a longitudinal axis of the cylinder and inclined at an angle α to the longitudinal axis of the cylinder, at least two of the plurality of nozzle holes including opening cross-sections of different size.

In this way, at least two nozzle holes of an injection nozzle of the internal combustion engine do not have uniform geometry but rather have different geometry. Said nozzle holes are characterized by opening cross sections of different size, whereas the nozzle holes of a conventional injection nozzle are of uniform design. The opening cross section of the nozzle hole has a significant influence on the impetus of the fuel jet emerging from the nozzle hole, wherein the impetus can be increased by increasing the size of the cross section and reduced by decreasing the size of the cross section. The variation in the impetus from nozzle hole to nozzle hole as a result of the inclined installation position of the nozzle can be compensated for in this way. With such an internal combustion engine or injection nozzle, it is possible to realize a fuel injection which is uniform with regard to impetus into the combustion chamber of a cylinder, as a result of which the adverse effects described above may be eliminated.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows, in cross section, a cylinder of a first embodiment of the internal combustion engine in a side view.

FIG. 2 schematically shows the cylinder illustrated in FIG. 1 in a plan view.

FIGS. 3A and 3B show an example fuel injection nozzle from two sides according to an embodiment of the present disclosure.

FIG. 4 schematically shows an example engine system including a cylinder.

FIG. 5 is a flow chart illustrating an example method for supplying fuel to a cylinder according to an embodiment of the present disclosure.

### DETAILED DESCRIPTION

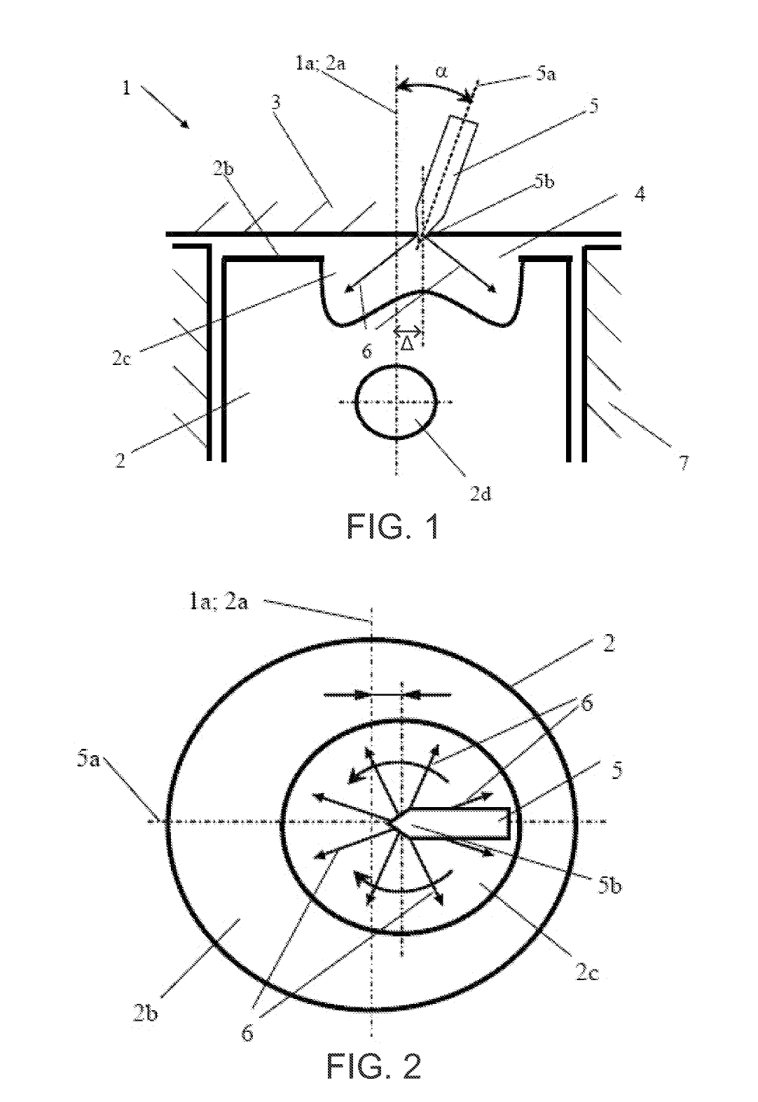

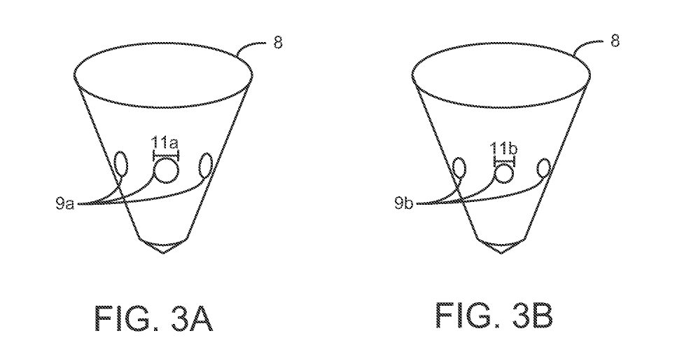

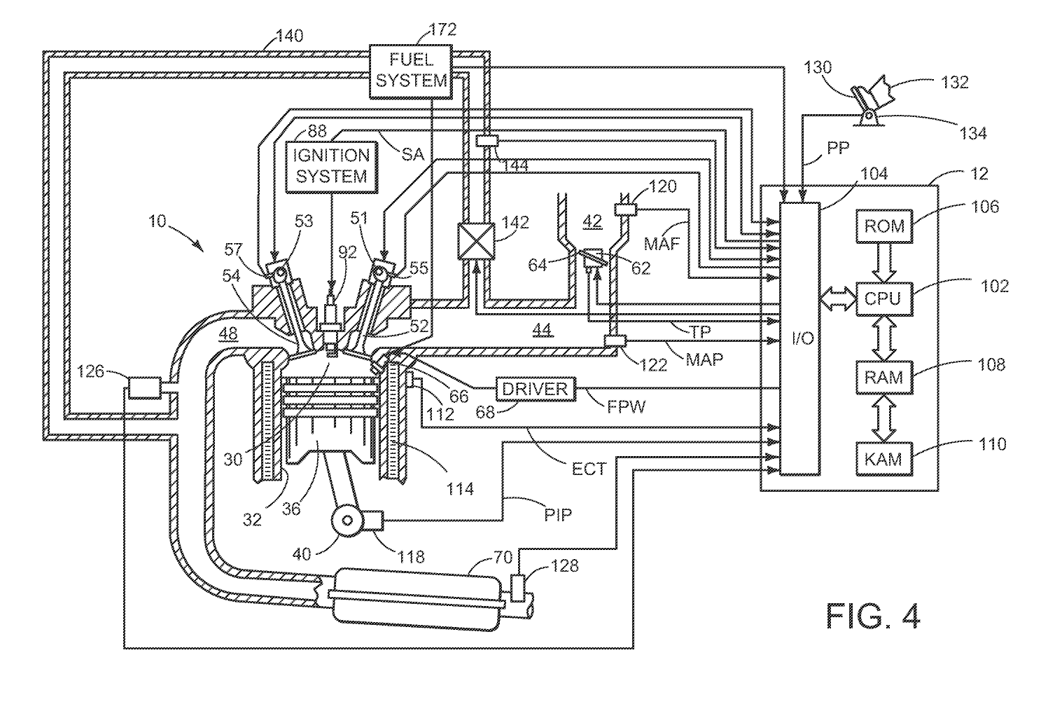

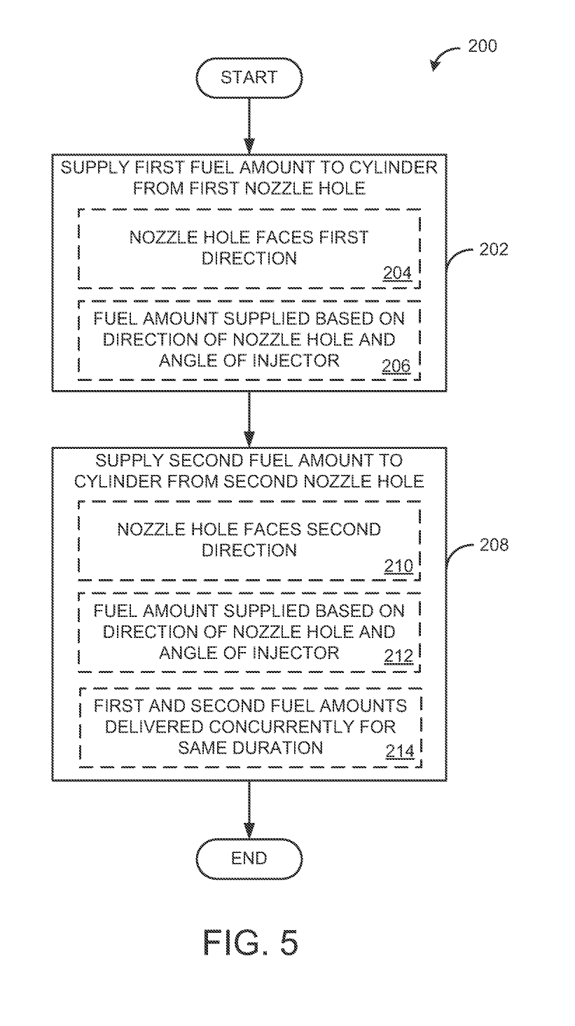

In order to reduce packaging space in an engine, one intake port may be provided per cylinder. To accommodate an opening of the intake port large enough to admit the desired amount of intake air, a fuel injection nozzle may be positioned at a distance away from the longitudinal axis of the cylinder. Additionally, the injection nozzle may be inclined at an angle. This may result in local areas of rich and lean air-fuel ratios in the cylinder. By providing injection nozzle holes of different sizes, a more uniform fuel injection may be provided. FIG. 1 schematically shows, in cross section, a cylinder of a first embodiment of the internal combustion engine in a side view. FIG. 2 schematically shows the cylinder illustrated in FIG. 1 in a plan view. FIGS. 3A and 3B show a fuel injection nozzle having holes of various sizes. FIG. 4 schematically shows an engine system including a cylinder and fuel injection nozzle. FIG. 5 shows a method of supplying fuel to a cylinder using the fuel injection system of FIGS. 1-4.

Turning to FIG. 1, the cylinder 1 comprises a combustion chamber 4 which is jointly formed by the piston crown 2b of a piston 2, a cylinder head 3 and a cylinder liner 7. The piston 2 can move in translatory fashion along its longitudinal axis 2a, which coincides with the longitudinal axis 1a of the cylinder 1. The piston 2 serves to transmit the gas forces generated by the combustion to a crankshaft. For this purpose, the piston 2 is connected in an articulated manner by a piston pin 2d to a connecting rod, which in turn is movably mounted on the crankshaft (not illustrated in FIG. 1).

On the opposite side of the piston crown 2b, an injection nozzle 5 is arranged in the cylinder head 3, which injection nozzle has, on its free end 5b projecting into the combustion chamber 4, a plurality of nozzle holes for directly injecting the fuel into the combustion chamber 4. In one embodiment, the injection nozzle may have eight holes, while in other embodiments it may have a different number of holes, such as five holes, six holes, etc.

The injection nozzle 5 is spaced apart, that is to say with a spacing Δ, from the longitudinal axis 1a of the cylinder 1, and is therefore arranged eccentrically. Furthermore, the injection nozzle 5 is inclined by an angle α with respect to the longitudinal axis 1a of the cylinder 1, wherein a denotes or indicates the angle between the longitudinal axis 5a of the injection nozzle 5 and the longitudinal axis 1a of the cylinder 1.

To compensate for or eliminate the effects conventionally arising from the inclined installation position of the nozzle 5, the nozzle holes may have diameters of different size. The two curved arrows shown in FIG. 2 indicate the direction in which the diameter of the holes decreases, specifically proceeding from the side facing away from the cylinder longitudinal axis 1a in the direction of the side facing toward the cylinder longitudinal axis 1a.

When using an injection nozzle with uniform nozzle opening cross section, the nozzle holes situated on the side facing away from the cylinder longitudinal axis would have the relatively low impetus. To account for this, according to the disclosure, the nozzle holes facing away from the axis may have a larger opening cross section in relation to the other holes.

In the case of three and more nozzle holes per injection nozzle, the opening cross sections of the holes may become increasingly larger with increasing distance from the cylinder longitudinal axis, that is to say in the direction of the side facing away from the cylinder longitudinal axis.

Embodiments of the internal combustion engine are advantageous in which the opening cross section of the at least two nozzle holes increases proceeding from the side facing toward the cylinder longitudinal axis in the direction of the side facing away from the cylinder longitudinal axis.

The piston crown 2b of the piston 2 is provided with a piston depression 2c which, correspondingly to the injection nozzle 5, is arranged in the piston crown 2b so as to be spaced apart from the longitudinal axis 1a of the cylinder 1. The piston depression 2c serves, in interaction with the injection nozzle 5, for the mixing and therefore the homogenization of the fuel/air mixture in the combustion chamber 4.

The injection jets 6 emerging from the nozzle holes impinge on the surface of the depression 2c, as a result of which the injected fuel is further distributed in the combustion chamber 4. Despite the limited opening angle of the injection cone formed from the injection jets 6, fast mixing takes place with the air situated outside the piston depression 2c.

The nozzle holes whose impetus would be small in relation to the other nozzle holes on account of the nozzle inclination may be provided with a larger opening cross section, whereas nozzle holes with a comparatively large impetus even with the nozzle inclination may be provided with a smaller opening cross section.

The internal combustion engine according to the disclosure, which is characterized in that nozzle holes of an injection nozzle arranged in the cylinder head have opening cross sections of different size, therefore achieves the object of providing a direct-injection internal combustion engine which is improved with regard to the injection of fuel and in which in particular the effects resulting from the inclined position of the nozzle and known previously are eliminated or lessened.

Embodiments of the internal combustion engine in which the injection nozzle of the at least one cylinder is provided with three or more nozzle holes, of which not all have a different size of opening cross section, may be provided as long as at least two nozzle holes have opening cross-sections of different size, that is to say as long as at least two different sizes of opening cross section are encountered when all of the nozzle holes are taken into consideration.

Embodiments of the internal combustion engine are advantageous in which the at least two nozzle holes have a substantially circular cross section. A symmetrically designed nozzle hole with a symmetrical, that is to say circular cross section offers production advantages and therefore also cost advantages.

In the case of internal combustion engines in which the nozzle holes have a substantially circular cross section, embodiments are advantageous in which the at least two nozzle holes are provided with diameters of different size in order to form opening cross sections of different size.

Here, embodiments of the internal combustion engine are advantageous in which the diameter of the nozzle holes increases proceeding from the side facing toward the cylinder longitudinal axis in the direction of the side facing away from the cylinder longitudinal axis.

In this connection, embodiments of the internal combustion engine are advantageous in which the diameter of the at least two nozzle holes vary by up to 25%. In particular, embodiments of the internal combustion engine are advantageous in which the diameter of the at least two nozzle holes vary by up to 18%. Furthermore, embodiments of the internal combustion engine are advantageous in which the diameter of the at least two nozzle holes vary by at least 5%, preferably at least 10%.

The variation of the diameter of the nozzle holes may preferably be coordinated with the angle of inclination of the injection nozzle, that is to say the greater the degree to which the installation position of the injection nozzle is inclined, the more pronounced the variation of the diameters may be. This corresponds to the fact that the impetuses of the injection jets differ to a greater extent with increasing angle of inclination.

Embodiments of the internal combustion engine are advantageous in which the injection nozzle is inclined at an angle α≦30°, preferably at an angle α≦20°, with respect to the longitudinal axis of the cylinder. Embodiments of the internal combustion engine are advantageous in which the injection nozzle is inclined at an angle α≧5°, preferably at an angle α≧10°, with respect to the longitudinal axis of the cylinder.

As has already been explained, a large inlet opening requires an inclined installation position of the injection nozzle in order to provide adequate installation space for the inlet valve and the inlet camshaft. It may however be taken into consideration that, although an inclined injection nozzle increases the space availability on the inlet side, it simultaneously also decreases the installation space on the outlet side in which the outlet valves and in particular the outlet camshaft are arranged. In this respect, the injection nozzle may be arranged so as to be inclined with respect to the longitudinal axis of the cylinder by an angle α which permits the use of a single inlet opening per cylinder and, in so doing, does not disadvantageously restrict the structural design on the outlet side.

In this connection, embodiments of the internal combustion engine are advantageous in which the injection nozzle is inclined at an angle of 7°≦α≦15° with respect to the longitudinal axis of the cylinder.

Embodiments of the internal combustion engine are advantageous in which the injection nozzle has at least three, preferably at least five nozzle holes, in particular seven or eight nozzle holes. A certain number of nozzle holes ensures firstly as widespread as possible a distribution of the fuel in the combustion chamber, with which wide regions of the combustion chamber are covered by the injection jets, which is advantageous in particular with regard to the homogenization of the air/fuel mixture.

Secondly, it may be taken into consideration that the injection nozzle may be capable of injecting not only relatively small amounts of fuel in the low and medium part-load ranges but rather also relatively large amounts of fuel at higher loads, specifically in a relatively short period of time which, depending on the rotational speed of the internal combustion engine, may be a few milliseconds. Since, with regard to the formation of the injection jet, the diameter of the nozzle holes cannot be enlarged arbitrarily, it is necessary, in order to increase the total cross section of all the holes, to increase the number of holes.

In a preferred embodiment, the nozzle holes are arranged annularly, that is to say on an imaginary ring, and spaced apart from one another, wherein here, annular does not imperatively mean circular. Here, the nozzle holes lie on an imaginary line, the end of which adjoins the start of the line again, that is to say the line forms a closed path. The nozzle holes of the injection nozzle may be arranged spaced apart from one another at regular intervals.

Embodiments of the internal combustion engine are advantageous in which the injection nozzle is a multi-hole injection nozzle, in particular an inwardly opening multi-hole injection nozzle.

Embodiments of the internal combustion engine are advantageous in which the injection nozzle is provided with a nozzle needle which is movable in the direction of its longitudinal axis in a nozzle needle guide between a rest position and a working position, wherein the nozzle needle closes off the at least two nozzle holes in the rest position and opens up said nozzle holes, in order to inject the fuel, in the working position. A nozzle needle permits the mechanical actuation of the injection nozzle and control of the injection process.

Embodiments of the internal combustion engine are advantageous in which the combustion of the fuel/air mixture is initiated by means of auto-ignition, that is to say in which the internal combustion engine is a diesel engine.

In the case of direct-injection diesel engines, embodiments of the internal combustion engine are advantageous in which the injection nozzle is a piezoelectric or magnetically controlled injection nozzle.

Embodiments of the internal combustion engine are advantageous in which the piston crown of the piston is provided with a piston depression. A small amount of time is available for the injection of the fuel, for the mixture preparation in the combustion chamber, that is to say the mixing of air and fuel and the preparation of the fuel within the context of preliminary reactions including evaporation, and for the ignition of the prepared mixture. A piston depression—which is preferably omega-shaped—arranged in the piston crown is advantageous for distributing the fuel throughout the entire combustion chamber and ensuring fast mixing of the injected fuel with the compressed gases.

When the fuel injection jets impinge on the depression surface, they are split into a plurality of divergent fuel partial jets which also accelerate the fuel out of the piston depression, such that optimum air utilization is ensured. In this way, fast mixing takes place despite the limited opening angle of the injection cone formed from the injection jets. The splitting of the injection jets into a plurality of partial jets and the acceleration of said partial jets out of the piston depression utilizing the kinetic energy of the injected fuel basically assists the mixture preparation, in particular the homogenization of the mixture.

In internal combustion engines whose pistons are provided with a piston depression, embodiments may be advantageous in which the piston depression is formed not correspondingly to the injection nozzle, that is to say eccentrically, but rather centrally in the piston crown, such that the longitudinal axis of the depression coincides with the longitudinal axis of the piston. Said embodiment makes allowance for the fact that, during the compression, the piston depression has a significant influence on the movement of the cylinder fresh charge in the combustion chamber.

In internal combustion engines having a crankshaft mounted so as to be rotatable about an axis of rotation, embodiments are advantageous in which the injection nozzle is arranged spaced apart from a plane in which both the axis of rotation of the crankshaft and also the longitudinal axis of the at least one cylinder lie.

FIGS. 3A and 3B schematically show a fuel injector nozzle tip 8. A first side of the fuel injector nozzle tip 8 is shown in FIG. 3A while a second side, situated opposite the first side, is shown in FIG. 3B. The view depicted in FIG. 3B is a 180° rotation of the view depicted in FIG. 3A. Both FIGS. 3A and 3B depict a plurality of nozzle holes, 9a and 9b respectively. The nozzle holes 9a, 9b each have a cross-sectional diameter that may be sized as a function of the angle of the injector nozzle and a distance from the longitudinal axis of a cylinder in which the nozzle is positioned, as explained above with respect to FIGS. 1 and 2. As can be seen in FIGS. 3A and 3B, the nozzle holes 9a may have a different cross-sectional diameter 11a than the cross-sectional diameter 11b of the nozzle holes 9b, as the nozzle holes 9a face in a different direction than the nozzle holes 9b.

Referring now to FIG. 4, a schematic diagram showing one cylinder of multi-cylinder engine 10, which may be included in a propulsion system of an automobile, is illustrated. Engine 10 may be controlled at least partially by a control system including controller 12 and by input from a vehicle operator 132 via an input device 130. In this example, input device 130 includes an accelerator pedal and a pedal position sensor 134 for generating a proportional pedal position signal PP. Combustion chamber (i.e., cylinder) 30 of engine 10 may include combustion chamber walls 32 with piston 36 positioned therein. Cylinder 1 and piston 2 described with respect to FIGS. 1 and 2 are non-limiting examples of a cylinder 30 and piston 36, respectively. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Further, a starter motor may be coupled to crankshaft 40 via a flywheel to enable a starting operation of engine 10.

Combustion chamber 30 may receive intake air from intake manifold 44 via intake passage 42 and may exhaust combustion gases via exhaust passage 48. Intake manifold 44 and exhaust passage 48 can selectively communicate with combustion chamber 30 via respective intake valve 52 and exhaust valve 54. In some embodiments, combustion chamber 30 may include two or more intake valves and/or two or more exhaust valves.

In this example, intake valve 52 and exhaust valves 54 may be controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT), and/or variable valve lift (VVL) systems that may be operated by controller 12 to vary valve operation. The position of intake valve 52 and exhaust valve 54 may be determined by position sensors 55 and 57, respectively. In alternative embodiments, intake valve 52 and/or exhaust valve 54 may be controlled by electric valve actuation. For example, cylinder 30 may alternatively include an intake valve controlled via electric valve actuation and an exhaust valve controlled via cam actuation including CPS and/or VCT systems.

Each cylinder of engine 10 may be configured with one or more fuel injectors for providing fuel thereto. As a non-limiting example, cylinder 30 is shown including one fuel injector 66, which is supplied fuel from fuel system 172. Fuel injector 66 is shown coupled directly to cylinder 30 for injecting fuel directly therein in proportion to the pulse width of signal FPW received from controller 12 via electronic driver 68. In this manner, fuel injector 66 provides what is known as direct injection (hereafter also referred to as “DI”) of fuel into combustion cylinder 30. Fuel injector nozzle 5 described above with respect to FIGS. 1 and 2 is one non-limiting example of a fuel injector 66. As such, fuel injector 66 may be located eccentrically within cylinder 30, and may be positioned at an angle with respect to a longitudinal axis of cylinder 30, as described with respect to FIG. 1.

It will be appreciated that in an alternate embodiment, injector 66 may be a port injector providing fuel into the intake port upstream of cylinder 30. It will also be appreciated that cylinder 30 may receive fuel from a plurality of injectors, such as a plurality of port injectors, a plurality of direct injectors, or a combination thereof.

Continuing with FIG. 1, intake passage 42 may include a throttle 62 having a throttle plate 64. In this particular example, the position of throttle plate 64 may be varied by controller 12 via a signal provided to an electric motor or actuator included with throttle 62, a configuration that is commonly referred to as electronic throttle control (ETC). In this manner, throttle 62 may be operated to vary the intake air provided to combustion chamber 30 among other engine cylinders. The position of throttle plate 64 may be provided to controller 12 by throttle position signal TP. Intake passage 42 may include a mass air flow sensor 120 and a manifold air pressure sensor 122 for providing respective signals MAF and MAP to controller 12.

In some embodiments, ignition system 88 can provide an ignition spark to combustion chamber 30 via spark plug 92 in response to spark advance signal SA from controller 12, under select operating modes. Though spark ignition components are shown, in some embodiments, combustion chamber 30 or one or more other combustion chambers of engine 10 may be operated in a compression ignition mode, with or without an ignition spark. Within the context of the present disclosure, the expression “internal combustion engine” encompasses in particular diesel engines but also hybrid internal combustion engines, that is to say internal combustion engines which are operated using a hybrid combustion process, and also spark-ignition engines.

An upstream exhaust gas sensor 126 is shown coupled to exhaust passage 48 upstream of emission control device 70. Upstream sensor 126 may be any suitable sensor for providing an indication of exhaust gas air-fuel ratio such as a linear wideband oxygen sensor or UEGO (universal or wide-range exhaust gas oxygen), a two-state narrowband oxygen sensor or EGO, a HEGO (heated EGO), a NOₓ, HC, or CO sensor.

Emission control device 70 is shown arranged along exhaust passage 48 downstream of exhaust gas sensor 126. Device 70 may be a three way catalyst (TWC), configured to reduce NOx and oxidize CO and unburnt hydrocarbons. In some embodiments, device 70 may be a NOₓ trap, various other emission control devices, or combinations thereof.

A second, downstream exhaust gas sensor 128 is shown coupled to exhaust passage 48 downstream of emissions control device 70. Downstream sensor 128 may be any suitable sensor for providing an indication of exhaust gas air-fuel ratio such as a UEGO, EGO, HEGO, etc.

Further, in some embodiments, an exhaust gas recirculation (EGR) system may route a desired portion of exhaust gas from exhaust passage 48 to intake passage 42 via EGR passage 140. The amount of EGR provided to intake passage 42 may be varied by controller 12 via EGR valve 142. Further, an EGR sensor 144 may be arranged within the EGR passage and may provide an indication of one or more of pressure, temperature, and concentration of the exhaust gas. Under some conditions, the EGR system may be used to regulate the temperature of the air and fuel mixture within the combustion chamber.

Controller 12 is shown in FIG. 4 as a microcomputer, including microprocessor unit 102, input/output ports 104, an electronic storage medium for executable programs and calibration values shown as read only memory chip 106 in this particular example, random access memory 108, keep alive memory 110, and a data bus. Controller 12 may receive various signals from sensors coupled to engine 10, in addition to those signals previously discussed, including measurement of inducted mass air flow (MAF) from mass air flow sensor 120; engine coolant temperature (ECT) from temperature sensor 112 coupled to cooling sleeve 114; a profile ignition pickup signal (PIP) from Hall effect sensor 118 (or other type) coupled to crankshaft 40; throttle position (TP) from a throttle position sensor; and absolute manifold pressure signal, MAP, from sensor 122. Engine speed signal, RPM, may be generated by controller 12 from signal PIP.

Storage medium read-only memory 106 can be programmed with computer readable data representing non-transitory instructions executable by processor 102 for performing the methods described below as well as other variants that are anticipated but not specifically listed.

As described above, FIG. 4 shows only one cylinder of a multi-cylinder engine, and each cylinder may similarly include its own set of intake/exhaust valves, fuel injector, spark plug, etc.

FIG. 5 is a flow chart illustrating a method 200 for supplying fuel to a cylinder according to an embodiment of the present disclosure. Method 200 comprises, at 202, supplying a first fuel amount to the cylinder from a first nozzle hole. Supplying the first fuel amount comprises determining the direction the first nozzle hole faces at 204. For example, the first nozzle hole may face toward a center of the cylinder, such as toward a central longitudinal axis of the cylinder. The first fuel amount supplied to the cylinder via the first nozzle hole may be based on the direction the hole faces at 206. Additionally, in some embodiments, the first fuel amount supplied may be based on an angle that the injector nozzle is inclined at.

At 208, method 200 comprises supplying a second fuel amount to the cylinder from a second nozzle hole. Supplying the second fuel amount comprises determining the direction the second nozzle hole faces at 210. For example, the second nozzle hole may face toward a side of the cylinder, such as away from the central longitudinal axis of the cylinder. The second fuel amount supplied to the cylinder via the second nozzle hole may be based on the direction the hole faces at 212. Additionally, in some embodiments, the second fuel amount supplied may be based on an angle that the injector nozzle is inclined at. In some embodiments, depending on the positioning of the injector nozzle, the second amount of fuel supplied may be different from the first amount. In this way, even though there may be differences in the impinging angle at which the fuel hits the cylinder between the two holes, an equal distribution of fuel/air mixture may be provided by supplying different amounts of fuel from the different nozzle holes. At 214, supplying the second fuel amount comprises supplying fuel concurrently with the first fuel amount for an equal duration. The fuel supplied to the cylinder via the first and second injector nozzle holes may be supplied during the same fuel injection event. Thus, the difference in the amount of fuel supplied is based solely on the size of the nozzle holes.

Thus, method 200 provides for supplying fuel to a cylinder via a plurality of injector nozzle holes. The holes may be sized differently depending on their position on the injector. By doing so, the fuel injected by the injector may have a more equal distribution in the cylinder, while still delivering the same total amount of fuel as traditional systems where the injector nozzles are sized equally.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A direct-injection internal combustion engine, comprising:
at least one cylinder in which a combustion chamber is jointly formed by a piston crown of a piston and by a cylinder head, each cylinder having an inlet opening for the supply of fresh air; and
an injection nozzle which is arranged in the cylinder head on the opposite side of the piston crown, on which injection nozzle, at a free end projecting into the combustion chamber, are provided a plurality of nozzle holes for the direct injection of the fuel, the injection nozzle being arranged eccentrically, spaced apart from a longitudinal axis of the cylinder and inclined at an angle α to the longitudinal axis of the cylinder, at least two of the plurality of nozzle holes including opening cross-sections of different size.

2. The internal combustion engine as claimed in claim 1, wherein the opening cross-section of the at least two nozzle holes increases proceeding from a side facing toward the cylinder longitudinal axis in a direction of the side facing away from the cylinder longitudinal axis.

3. The internal combustion engine as claimed in claim 1, wherein the at least two nozzle holes have a substantially circular cross-section.

4. The internal combustion engine as claimed in claim 3, wherein the at least two nozzle holes are formed with diameters of different size in order to form opening cross-sections of different size.

5. The internal combustion engine as claimed in claim 4, wherein the diameters of the at least two nozzle holes vary by up to 25%.

6. The internal combustion engine as claimed in claim 4, wherein the diameters of the at least two nozzle holes vary by up to 18%.

7. The internal combustion engine as claimed in claim 4, wherein the diameters of the at least two nozzle holes vary by at least 5%.

8. The internal combustion engine as claimed in claim 4, wherein the diameters of the at least two nozzle holes vary by at least 10%.

9. The internal combustion engine as claimed in claim 1, wherein the injection nozzle is arranged so as to be inclined by an angle α≦30° with respect to the longitudinal axis of the cylinder.

10. The internal combustion engine as claimed in claim 1, wherein the injection nozzle is arranged so as to be inclined by an angle α≦20° and/or α≧5° with respect to the longitudinal axis of the cylinder.

11. The internal combustion engine as claimed in claim 1, wherein the injection nozzle has at least five nozzle holes.

12. The internal combustion engine as claimed in claim 1, wherein the internal combustion engine is a diesel engine.

13. The internal combustion engine as claimed in claim 1, wherein the piston crown of the piston is provided with a piston depression.

14. The internal combustion engine as claimed in claim 1, further comprising a crankshaft mounted so as to be rotatable about an axis of rotation, wherein the injection nozzle is arranged spaced apart from a plane in which both the axis of rotation of the crankshaft and also the longitudinal axis of the at least one cylinder lie.

15. A method for injecting fuel in a cylinder, comprising:
supplying a first fuel amount in a first direction from a first injector nozzle hole; and
supplying a second fuel amount, different from the first fuel amount, in a second direction from a second injector nozzle hole.

16. The method of claim 15, wherein the first and second fuel amounts are set based on a direction the fuel is supplied in relative to the cylinder.

17. The method of claim 16, further comprising supplying the first fuel amount in a direction toward a longitudinal axis of the cylinder and supplying the second fuel amount in a direction away from the longitudinal axis of the cylinder.

18. The method of claim 16, wherein the first fuel amount and the second fuel amount are supplied to the cylinder concurrently for an equal duration.

19. A fuel injection system, comprising:
a cylinder;
a fuel injector located in the cylinder at a distance from a central longitudinal axis of the cylinder and positioned at an angle with regard to the central longitudinal axis; and
a plurality of injector nozzle holes arranged annularly on the fuel injector, the plurality of injector nozzle holes each having a respective cross-sectional diameter sized as a function of the angle of the fuel injector and a distance of each respective nozzle hole from the central longitudinal axis.

20. The fuel injection system of claim 19, wherein at least two of the plurality of injector nozzle holes have cross-sectional diameters that are different from each other by at least 5%.
